(19) United States
(12) Patent Application Publication
(10) Pub. No.: US 2009/0037221 A1
(43) Pub. Date: Feb. 5, 2009

(54) SYSTEMS AND METHODS FOR PROVIDING CUSTOMIZABLE PILL BOTTLE SLEEVES

(76) Inventors: Theresa Litherland, Elkton, MD (US); Michael Forehand, Avondale, PA (US); Janice Jackson, Chaddsford, PA (US); Juliet McQuillan, Wilmington, DE (US); Kathy Monday, Glen Mills, PA (US); Adele Gulfo, New York, NY (US); Shaun Walsh, West Chester, PA (US); Craig Huber, Haddon Heights, NJ (US); David Satre, Hockessin, DE (US); Broderick A. Jones, Philadelphia, PA (US); Kenneth E. Jewel, Boston, MA (US); Bella Wong, Conshohocken, PA (US)

Correspondence Address: Weiss & Arons, LLP, 1540 Route 202, Suite 8, Pomona, NY, 10970, US

(21) Appl. No.: 11/832,222

(22) Filed: Aug. 1, 2007

(51) Int. Cl. B65D 25/34; A61J 1/03; G09F 3/04; G06F 19/00; G06Q 50/00

(52) U.S. Cl. 705/3; 206/534; 220/694; 40/310; 705/2

(57) ABSTRACT

Systems and methods for providing customizable sleeves for pill bottles, customizable adhesive attachments, customizable Post-it notes and methods for the manufacture thereof are provided. Also provided are methods of surveying pharmacists regarding the effect of customizable adhesive attachments to a pill bottle. The method may include using a digital computer to receive information relating to issues in implementation of a system for providing customizable adhesive attachments. The customizable adhesive attachments may be attached to the bottle. The adhesive attachments may be customizable with respect to at least two of 1) color; 2) content; and 3) texture. The method may further include using a digital computer to receive information relating to benefits obtained from the adhesive attachment.

### BACKGROUND OF THE INVENTION

This patent application relates to pills and pill bottles. More specifically, this application relates to a pill bottle that may incorporate multiple informational features.

Many pill bottles do not maintain highly-informative and conspicuous elements and, thereby, may serve to discourage patients from following appropriate medication regimens. Furthermore, such pill bottles have a sterile appearance which also tends to deter proper patient adherence to a prescribed course of medicine.

While certain pill bottles incorporate informational features, additional such features may increase the approachability of taking medicine, as well as transition the look and feel of such a pill bottle from a medical feel to a more informative feel.

It would be desirable to incorporate one or more informational features into a pill bottle.

It would be further desirable to provide a pill bottle with an enhanced look and feel that focuses on user-friendliness and motivation to take medicine.

### SUMMARY OF THE INVENTION

It is an object of the invention to incorporate one or more informational features into a pill bottle.

It is a further object of this invention to provide a pill bottle with an enhanced look and feel that focuses on user-friendliness and motivation to take medicine.

A method of surveying the effect of adhesive adherents to a pill bottle is also included in the invention. The method may include using a digital computer to receive information relating to how well a plurality of patients succeeded in managing their respective medication regimen. The medication regimen may include taking medication with adhesive adherents adhered to the bottle. The adhesive adherents may be customizable with respect to at least two of 1) color; 2) content; and 3) texture. the method may also include using a digital computer to receive information relating to what medications the patients are currently prescribed.

In one aspect of the invention, a pill bottle incorporating enhanced features may be filled with pills. Such pills according to the invention may be any pills that are specified in the FDA Orange Book for approved medications.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows two customizable sleeves according to the invention;

FIG. 2 shows two customizable textured sleeves according to the invention;

FIG. 3 shows customizable stickers according to the invention for adhesion to a pill bottle and/or cap;

FIG. 4 shows a medication card according to the invention with certain rules for the medication which may be coded to a color or pattern that could be adhered to the medication according to the invention;

FIG. 5 shows a tent card according to the invention; and

FIG. 6 shows a plurality of pills bottles, the wider of the bottles with an information portion according to the invention;

FIG. 7 shows a digital computer and printer for use with methods according to the invention; and

FIG. 8 shows additional embodiments of materials that can be used to form tent card according to the invention.

### DETAILED DESCRIPTION OF THE INVENTION

As will be appreciated by one of skill in the art upon reading the following disclosure, various aspects described herein may be embodied as a method, a data processing system, a computer program product, or other suitable digital computer-related application. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized. Such media may include hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires and/or optical fibers. The signals may also be transmitted using wireless transmission media (e.g., air and/or space).

Research has shown that the patient burden taking multi-medications is significant. Managing multi-medications and remembering what each medication is for, and when and how to take each medication leads to medication errors and non-compliance. This is a problem for certain patients. One study shows that 73% of patients taking Crestor™, manufactured by Astra Zeneca, based in Sweden, are on more than 3 medications. The percentage is similar or higher for many other medications.

Experiential evidence in the form of patient interviews has also shown that patients would really like to have basic, easy to understand information on their prescriptions. This information was consistently reiterated by a number of different focus groups of patients and caregivers. The basic information was
1) Who is the medication for?
Grandpa Jim's medication
2) What is the medication and what is it for?
Crestor™ for heart health
3) How and when do I take this medication?
Take 1 pill in the morning

In an effort to improve the patient experience and patient health for anyone taking medication, it would be beneficial to find a way to support providing more information to patients in an easily understood, and readily-visible format.

One aspect of the invention is to solve these problems by providing systems and methods for offering a custom-printed, or otherwise customizable, sleeve that fits over the amber pill vial, or other suitable medicine container. The sleeve may include information relating to—what the medication is for, when to take the medication, and how to take the medication. The information can be customized for each patient's medication regimen, a physician's instructions, and a few custom features a patient would choose.

The benefits derived from such systems and methods may include:

1) Improvement in the patient experience for anyone taking a medication;

2) Improved patient understanding, patient compliance, and overall patient health; and

3) An improved opportunity to incorporate a branded message to the patient.

Systems and methods for providing a customizable sleeve for medicine pills and other medicine containers are provided. Such sleeves may be based on interaction with a pharmacist. The interaction may be between the patient and the pharmacist and/or interaction between the physician/caregiver and the pharmacist.

In certain aspects of the invention, the customization of the sleeves may extend to various different features. Such features may include colors. For example, a particular patient or care giver may specify to a pharmacist, or, in alternative embodiments, may define on their own system set up on a home computer, colors of sleeves, stickers, or other objects that may be adhered to a medicine container.

In certain embodiments of the invention, such colors may correspond to certain times of the day. For example, if a medicine was required to be taken once a day in the morning, the color may be specified to be, or may be system-set to be, a bright yellow. Alternatively, if a medicine was required to be taken once a day in the evening, the color may be specified to be, or may be system-set to be, a dark blue.

In some embodiments of the invention, such customizable features may include the textures of the sleeves, stickers etc. For example, a particular patient or caregiver may specify to a pharmacist, or, in alternative embodiments, may define on their own system set up on a home computer, textures of sleeves, stickers, or other objects that may be adhered to a medicine container.

In certain embodiments of the invention, such textures may correspond to certain prescriptions. For example, if a medicine was required to be taken once a day, a “one(1)” may be repeatedly extruded on the sleeve so as to remind someone who grasped the medicine container that the prescription was for taking once a day. Alternatively, a certain texture, such as bumps or wavy lines may indicate a particular condition for taking the medication.

Such embodiments of the invention may be implemented by incorporating a miniature extruder into the device at the pharmacy, or by providing pre-molded sheets for forming the sleeves. The sheets may preferably incorporate a large number of optional textures that could be offered to the patient to select their preferred texture, color and/or other personal need. Such an approach may incorporate a questionnaire that is presented to the patient that the patient can respond to in order to define a customized medication sleeve or other device.

In yet other embodiments of the invention, the sleeve or other device may show indications that are particular to the patient—e.g., if the medicine disagrees with the patient when taken with milk. Such indications may be shown by a large X drawn through a bottle of milk. Accordingly, a library of graphic art may be incorporated into the system for use by a pharmacist. The system may be accessible by the pharmacist so the sleeve or other device can be tailored to the patient's needs.

The following criteria may be important in implementation of a pilot of the sleeve concept. One criteria of the customizable sleeve according to the invention is to develop something very intuitive, clear, and simple for patients. This extra information helps patients feel more in control and motivated to be adherent to their medication regiment. Another criteria is that the pharmacists may be incorporated into the process for forming the sleeve in order to guarantee that the instructions from the physician are transmitted accurately.

The following testing pilot structure may be used to implement systems and methods for providing a customizable sleeve for medicine containers according to the invention.

Determine one pharmacy chain that would like to provide this type of information to all their patients.

Select four, or some other suitable number of, retail locations to participate in the pilot matched for similar script rates and demographics

In two pharmacies, all patients prescribed certain selected medications would be recruited by the pharmacist to opt into the pilot. The two test pharmacies could provide a patient information card for anyone filling a script for the selected medications. In one embodiment of such a pilot, the patient information card may contain all of a patient's medication, not just the selected medications.

Two pharmacies can be used as control group.

Each month the patients can be surveyed in the test and control group.

The following questions may be used in the survey:

How well they did in managing their medication regimen?

What medications are they on and what are the medications for?

Do they recall the selected medications?

Do they recall the sponsor providing the helpful information?

Do they recall how to take each medication?

What additional information would the patients like?

Each month the pharmacists in the test group can also be surveyed. Such a survey may include the following questions:

Issues or challenges in implementation;

Benefits from the sleeve;

Notable patient reactions;

Improvements they would like; and

Whatever other input the pharmacists may have.

At the end of three months, or some other suitable time, an interim determination on the survey data along with an early determination on refill rates can be measured. The pilot according to the invention may be structured so that a go/no go decision can be made at this point.

If the pilot continues, the pilot may continue for a total of 12 months. The pilot may incorporate measuring refill rates on all selected brands and 2 more surveys at 6 months and 12 months may also be completed.

A pharmaceutical company that produces one of the selected medications may have the opportunity to place compliance information relevant to the brand or disease education relevant to the brand that the patient is already prescribed on the back of the customizable sleeve. A certain hierarchy of rules may need to be established on the type of information that can be included so that the intent of simple, clear information to the patient is not compromised.

Another embodiment of the invention may include printing a coupon/rebate card on the back of the information sleeve triggered by the number of refills the patient has had. For example, on the patients 5th Crestor™ script a patient could receive a coupon for $15 off their next refill.

In another embodiment of the invention, the features may include providing pictures of the medication. Such pictures may be obtained from a provider such as Medi-Span of Indianapolis, Ind., or other suitable provider.

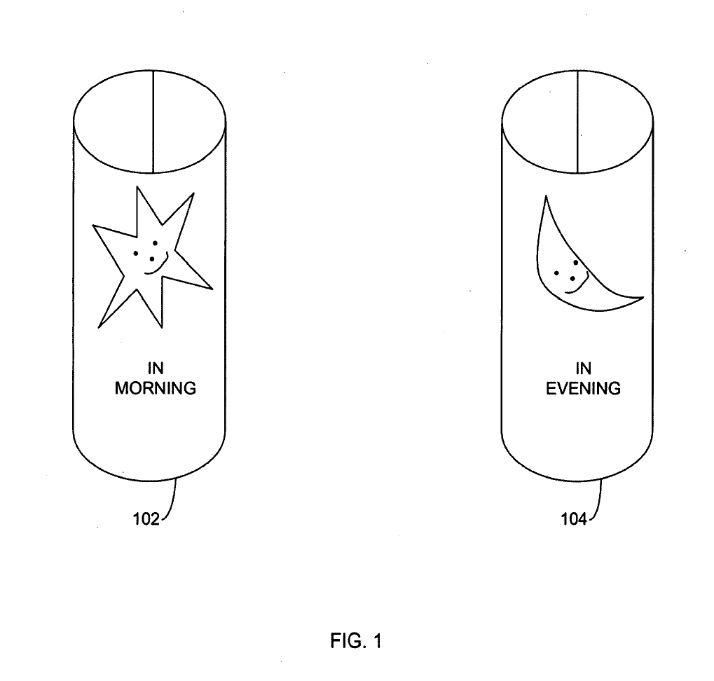

FIG. 1 shows two customizable sleeves according to the invention. In these exemplary sleeves, instructions are specified—one sleeve 102 indicates the medicine should be taken in the morning and one sleeve 104 indicates that the medicine should be taken in the evening. The indications in this particular example are made by way of illustrations that may be more readily recognizable than small type on a pharmacy label of an amber pill bottle.

Such sleeves according to the invention may preferably be attached or adhered in some suitable fashion to the outside of an amber pill bottle or some other suitable medicine container. Such sleeves may also include clearly-visible indications of the number of pills that should be taken. Furthermore, sleeves 102 and 104 may be color-coded to correspond with certain information. Such information may include time of day to take the information, and possible indications or warnings associated with the medication.

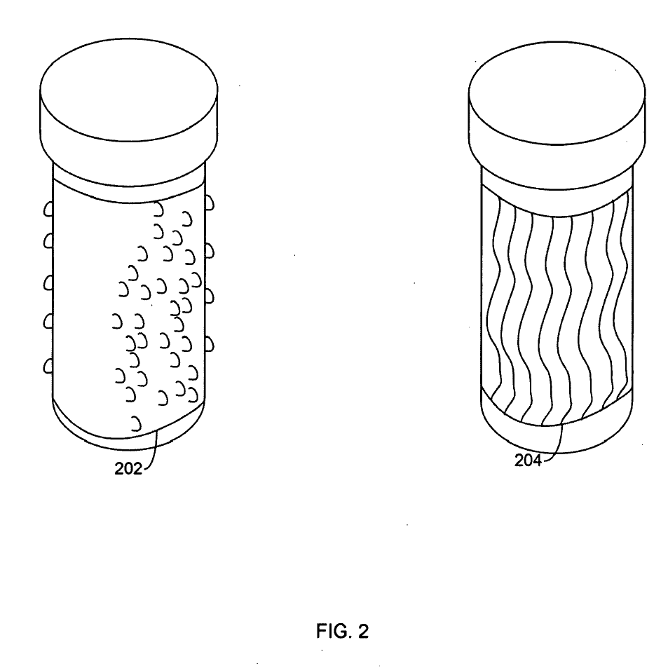

FIG. 2 shows two textured sleeves 202 and 204 that may be formed using methods according to the invention. Such sleeves may be texture-coded to include information on the sleeve such as number of times a day that the medicine is required to be taken. Such information may include the number 1, 2, 3 etc. embossed on the texture of the sleeve whereby the number signifies the number of times a day to take the medication.

In certain embodiments of the invention, the texture may signify the time of the day to take the medication such a texture of raised suns or raised moons.

In yet other embodiments of the invention, the texture on the sleeve may be preformed whereby certain textures may be presented to a patient to select therefrom in order for the patient to have some input as to what texture the patient needs to help him/her take the medication according to a certain specified regimen.

In an alternative embodiment of the invention, the texture may be formed by a stamping machine, an extruding machine or other suitable machine in accordance with control information as programmed by a pharmacist or other suitable caregiver. Such a method of formation may allow a user to fully define the texture of the sleeve to the extent of the capabilities of the extruding machine.

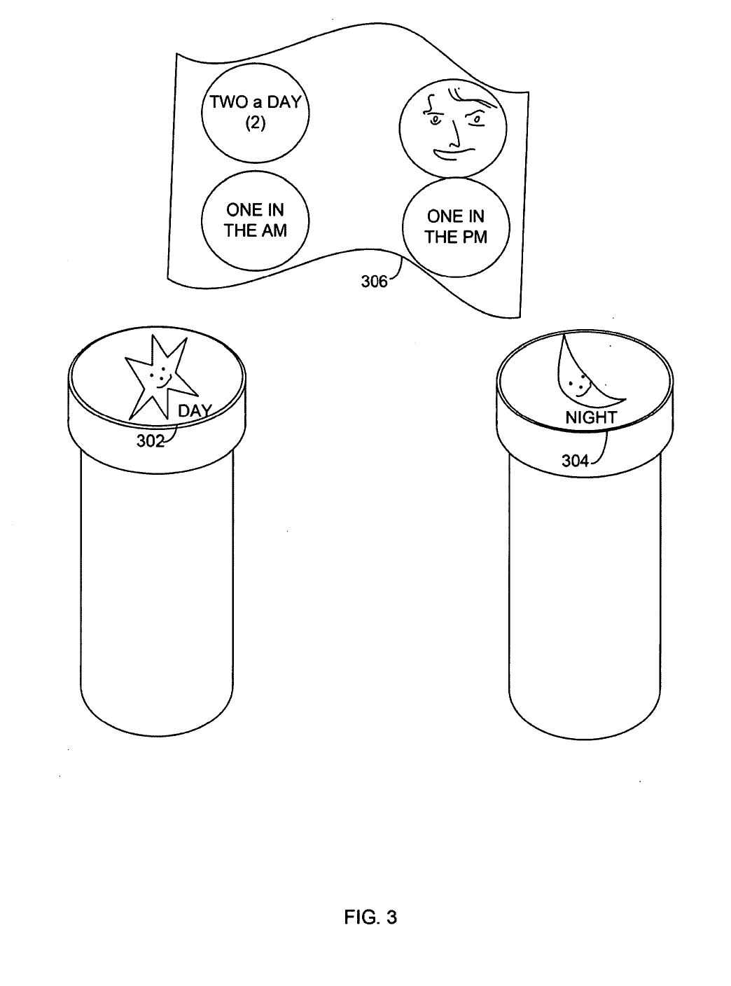

FIG. 3 shows customizable stickers 302 and 304 (alternatively referred to herein as “adhesive attachments”) that may preferably be adhered to the top of the cap of a pill container. Such stickers may readily be formed using known printer technology. Such stickers may be further formed on a sheet, such as sheet 306, which may be printed with a color printer.

Sheet 306 shows a number of messages that may be printed. These messages may include time of day to take medication, number of times to take medication, and/or the picture of a loved one that may further inspire the patient to take the medication. Such a sheet may preferably be printed by a pharmacist according to specifications set forth by a patient/caregiver. As such, such a sheet may be fully customizable in order to accurately meet the needs of a patient. Furthermore, such stickers may be easily and quickly adhered to the appropriate medication by a pharmacist without risking inaccurate application by a user.

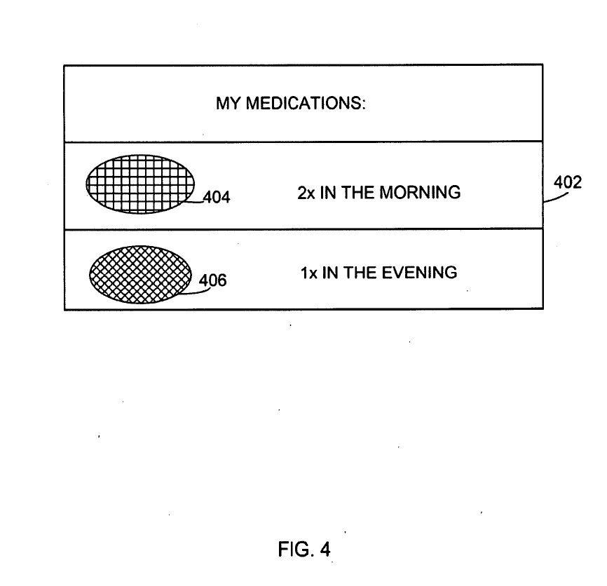

FIG. 4 shows a medication card with certain rules for the medication which may be coded to a color or pattern that could be adhered to the medication. Such a pattern may preferably appear in more easily visible indication on the card 406. Patterns may include pattern 402 and pattern 404. Matching patterns may be applied to the appropriate medication using either a preferably customizable sleeve or a preferably customizable sticker.

Additionally, a card such as the card 406 may preferably organize a patient's medication so the patient has a clear guide to the various medications that the patient is currently taking. As such, the patient can clearly refresh to him or herself the medications that he/she is taking as well as the dosage that is necessary at any one given period, such as the morning or night.

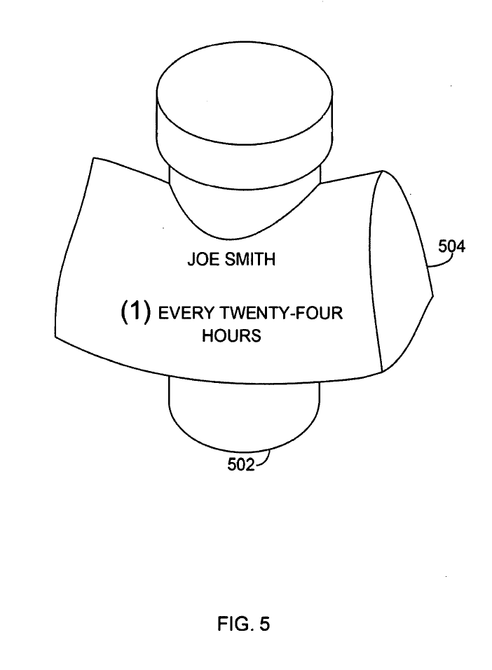

FIG. 5 shows yet another embodiment of a customizable medicine container enhancement according to the invention. Tent card 504, which may be slid over pill bottle 502, can include information such as the patient, the dosage, a picture of the medication itself, pictures of loved ones to help motivate the patient to take the medication, and other relevant information.

Such a tent card may preferably include the information in a more readily-readable display than was previously possible using just a pharmacy label on the outside of a pill bottle. Tent card 504 preferably addresses many of the issues set forth above such as the questions posed above: 1) Who is the medication for? 2) What is the medication and what is it for? 3) How and when do I take this medication? All these questions can be adequately addressed in the large display portions of tent card 504.

Furthermore, such a tent card can be easily adapted for printing by a pharmacist who can then slide the formed tent card over the pill bottle and substantially enhance the medication-taking experience of a patient by increasing the availability of the information relating to the medication.

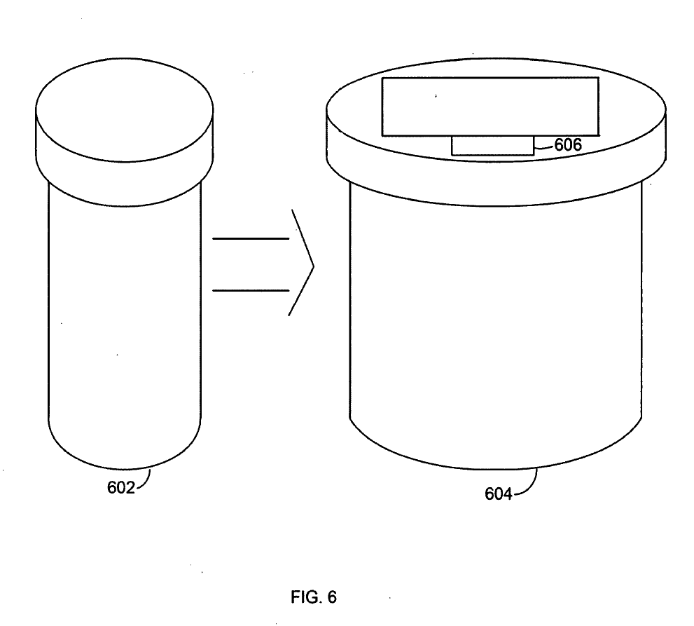

FIG. 6 shows two pill bottles 602 and 604. Pill bottle 604, which has a larger diameter than pill bottle 602, preferably may provide ample space for a peel-off fold-out booklet 606 that can be attached to the wider top of the bottle 604. Alternatively, a flag (that can roll up or fold up) on the cap of bottle 604 may also be implemented such that pharmaceutical information, or other information as described herein can preferably be disclosed in a way that is acceptable and accessible to a patient.

In yet other embodiments of the invention, Post-it notes™, such as Post-it notes manufactured by 3M Co. of Minn., preferably can be customized by the pharmacist for a particular patient and/or for a particular medication. Preferably, such Post-it notes can include information as described herein. Such information can be removed from the bottle and adhered in multiple locations as desired.

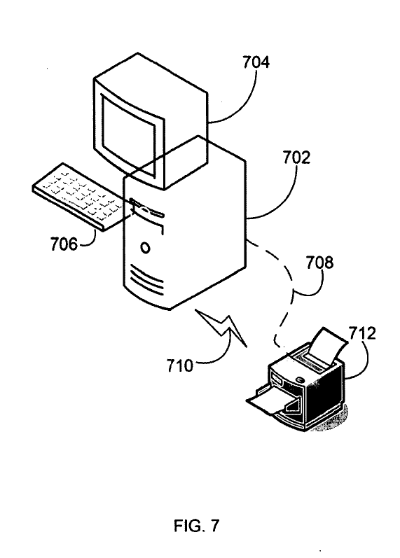

FIG. 7 shows a digital computer 702, monitor 704, keyboard 706, wired connection 708 to printer and a printer 712, as well as wireless connection 710. As is well known in the art, suitable adhesive paper can be fed into printer 712 and in response to a suitable graphics/word processing application command, printer 712 can preferably print pill bottle adhesive attachments according to the invention. Such adhesives can be printed to include any of the information described in more detail herein and, as such, a relatively inexpensive system can be utilized by a pharmacist to deliver, in response to a patient/caregiver questionnaire or interview, a customized and targeted adhesive attachment.

It should be noted that such a digital computer as shown and described in FIG. 7 may also be used as a workstation for administering a survey as described in more detail above.

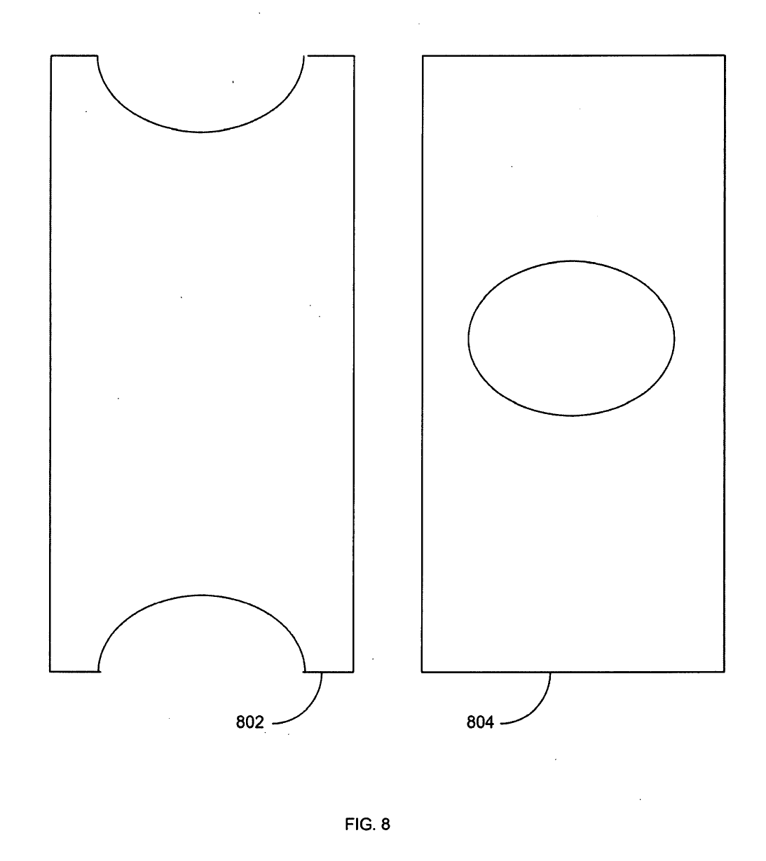

FIG. 8 shows additional embodiments of materials that can be used to form tent cards according to the invention. Material 802 is shown with two semi-circular cutouts at either end. The ends may be affixed to one another using adhesive or other suitable methods. When the ends of material 802 have been affixed to one another, the pill bottle, which may be of any suitable size, can be placed in the hole formed by the joining of the two-semicircular features. In such an embodiment, the pill bottle, once inserted in the hole, may sit on the center portion of the material 802.

An embodiment including material 804 can be implemented by inserting a pill bottle in the hole so the material forms a tent about the pill bottle.

Thus, customizable sleeves, other customizable pill container adhesive attachments, customizable Post-it™ notes, and methods of making such customizable items according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. A customizable pill bottle sleeve.

2. The customizable pill bottle sleeve of claim 1 further comprising a tent card.

3. The customizable pill bottle sleeve of claim 1 further comprising customizable content.

4. The customizable pill bottle sleeve of claim 1 further comprising a customizable color.

5. The customizable pill bottle sleeve of claim 1 further comprising a customizable texture.

6. The customizable pill bottle sleeve of claim 1 further comprising a customizable adhesive attachment.

7. The customizable pill bottle sleeve of claim 1 further comprising content that is customizable with respect to the reason for taking the medicine.

8. A pill bottle including a plurality of pills and a customizable sleeve as claimed in claim 1.

9. A customizable pill bottle adhesive attachment.

10. The customizable pill bottle adhesive attachment of claim 9 further comprising a tent card.

11. The customizable pill bottle adhesive attachment of claim 9 further comprising customizable content.

12. The customizable pill bottle adhesive attachment of claim 9 further comprising a customizable color.

13. The customizable pill bottle adhesive attachment of claim 9 further comprising a customizable texture.

14. The customizable pill bottle adhesive attachment of claim 9 further comprising a customizable adhesive attachment.

15. The customizable pill bottle adhesive attachment of claim 9 further comprising content that is customizable with respect to the reason for taking the medicine.

16. A pill bottle including a plurality of pills and a customizable pill bottle adhesive attachment as claimed in claim 9.

17. A method of surveying the effect of adhesive adherents to a pill bottle, the method comprising:
using a digital computer to receive information relating to how well a plurality of patients succeeded in managing their respective medication regimen, said medication regimen including taking medication with adhesive adherents adhered to the bottle, said adhesive adherents being customizable with respect to at least two of 1) color; 2) content; and 3) texture; and
using a digital computer to receive information relating to what medications the patients are currently prescribed.

18. The method of claim 17 further comprising using a digital computer to receive information relating to the purpose of the medications.

19. The method of claim 17 further comprising using a digital computer to receive information relating to whether the patients recall selected medications.

20. The method of claim 17 further comprising using a digital computer to receive information relating to whether the patients recall how to take each medication.

21. The method of claim 17 further comprising using a digital computer to receive information relating to what additional information would the patients like.

22. A method of surveying the effect of customizable sleeves to a pill bottle, the method comprising:
using a digital computer to receive information relating to how well a plurality of patients succeeded in managing their respective medication regimen, said medication regimen including taking medication with customizable sleeves attached to the bottle, said sleeves being customizable with respect to at least two of 1) color; 2) content; and 3) texture; and
using a digital computer to receive information relating to what medications the patients are currently prescribed.

23. The method of claim 22 further comprising using a digital computer to receive information relating to the purpose of the medications.

24. The method of claim 22 further comprising using a digital computer to receive information relating to whether the patients recall selected medications.

25. The method of claim 22 further comprising using a digital computer to receive information relating to whether the patients recall how to take each medication.

26. The method of claim 22 further comprising using a digital computer to receive information relating to what additional information would the patients like.

27. A method of surveying pharmacists regarding the effect of customizable sleeves to a pill bottle, the method comprising:
using a digital computer to receive information relating to issues in implementation of a system for providing customizable sleeves, said customizable sleeves attached to the bottle, said sleeves being customizable with respect to at least two of 1) color; 2) content; and 3) texture; and
using a digital computer to receive information relating to benefits obtained from the sleeve.

28. The method of claim 27 further comprising using a digital computer to receive information relating to notable patient reactions.

29. The method of claim 27 further comprising using a digital computer to receive information relating to improvements that the pharmacists believe may enhance the customizable sleeves.

30. A method of surveying pharmacists regarding the effect of customizable adhesive attachments to a pill bottle, the method comprising:
using a digital computer to receive information relating to issues in implementation of a system for providing customizable adhesive attachments, said customizable adhesive attachments attached to the bottle, said adhesive attachments being customizable with respect to at least two of 1) color; 2) content; and 3) texture; and
using a digital computer to receive information relating to benefits obtained from the adhesive attachment.

31. The method of claim 30 further comprising using a digital computer to receive information relating to notable patient reactions.

32. The method of claim 30 further comprising using a digital computer to receive information relating to improvements that the pharmacists believe may enhance the customizable adhesive attachments.
